(19) United States
(12) Patent Application Publication
(10) Pub. No.: US 2007/0151380 A1
(43) Pub. Date: Jul. 5, 2007

(54) Specimen stage

(75) Inventor: Vinzenz Orasche, Eberndorf (AT)

Correspondence Address: ECKERT SEAMANS CHERIN & MELLOTT, 600 GRANT STREET, 44TH FLOOR, PITTSBURGH, PA, 15219, US

(73) Assignee: Wild GmbH, Volkermarkt (AT)

(21) Appl. No.: 11/299,575

(22) Filed: Dec. 12, 2005

(51) Int. Cl. F16H 1/04

(52) U.S. Cl. 74/422

(57) ABSTRACT

A specimen stage comprises a support and an elongated guidance of a first length on the support. At least one displaceable plate is on the support to be guided by the guidance. There is a driving arrangement for displacing the plate. The driving arrangement comprises at least one rotatable shaft, an actuator coupled to the shaft for rotating it, a pinion associated and coupled to the shaft for transmitting rotation, and a toothed rack of a second length, the teeth of which engage the teeth of the pinion so as to convert the rotary motion of the pinion into a linear motion of the rack. The rack is flexible and is guided in at least one bent section, and suitably also a linear section. To provide some rigidity despite of the flexibility, the teeth of the rack are machined into a body of a halogenated ethylene. Suitably, the pinion engages the rack at the radial outer side with respect to the bent section. The shaft may be releasably coupled to the pinion to enable an easy exchange.

### FIELD OF THE INVENTION

This invention relates to a specimen stage, particularly for a microscope, comprising a support plate and a displaceable plate arranged above the support plate, which is guided by an elongated guiding arrangement of a first length. This guiding arrangement comprises guiding surfaces. A driving mechanism is provided for displacing the displaceable plate: the driving mechanism comprises a rotatable shaft, an actuator that is coupled to the shaft for rotating it to displace the displaceable plate. Furthermore, the driving mechanism comprises a transmitting mechanism for transmitting the movement of the actuator to the plate. This transmitting mechanism includes (at least one) pinion coupled to the shaft for transmitting rotation from the driving mechanism, and a toothed rack of a second length. The rack comprises teeth which engage the pinion and is coupled to the displaceable plate for displacing it. There is a coupling to couple the toothed rack to the displaceable plate. In this arrangement, the guiding arrangement is in guiding connection to the toothed rack, wherein the first length of the guiding arrangement is longer than the second length of the rack. The guiding arrangement comprises at least one curved section, and suitably at least one linear section so that the rack has to be flexible.

Although specimen stages of the above-mentioned type are usually used in microscopes, they can be used for a variety of applications.

### BACKGROUND OF THE INVENTION

A specimen stage for microscopes according to WO 97/26576 A1 comprises a stationary support plate and, in the case of an embodiment where the specimen stage is formed as a cross slide and comprises two sliding plates connected to it. These sliding plates are displaceable in the direction of x, y coordinates. A driving arrangement is provided for displacing the sliding plates. Two coaxial turning knobs serve as an actuator.

These coaxial turning knobs are firmly connected each to a pinion each via a rotating shaft, the pinions engaging the teeth of rigid toothed racks. Each one of the rigid toothed racks is firmly connected to the associated sliding plate so that any turning movement of the corresponding turning knob is transmitted to the associated sliding plate.

It is often a requirement for observing objects that a displacing stroke as large as possible is made available, and known designs provide a toothed rack distinguishably longer than the associated sliding plate. However, this construction has the disadvantage that the toothed rack exceeds the length of the sliding plate considerably so that there not only higher space requirements, e.g. for a microscope specimen stage, but turning the specimen stage in some cases necessary for observing an object, is no longer possible or only to a restricted extent.

In order to avoid such disadvantages, DD-226 091 A1 suggested a cable pull as a drive for a sliding plate, where the cable is guided around two deflection pulleys. The sliding plate is connected in a non-positive manner. The deflection pulleys are located within the limits of the support plate and are driven by a rotating shaft. Such a known construction is expensive by the number of components and needs much of maintenance and service work, because the cable is subjected to high wear. A further disadvantage is that it tends to vibrations which affect the necessary precision of adjustment.

A flexible toothed rack cooperating with a pinion is known in a conveyor according to U.S. Pat. No. 3,822,606 as a transmitting unit for transforming rotational movement into a linear movement. The flexible toothed rack has such an elasticity, that it can be freely bend in every one of its sections.

DE.44 13 884 A1 discloses a vacuum cleaner having a slider as a component of a control of the number of revolutions of a fan motor. In this construction, a toothed rack entrained by a slider is guided in a linear and a bent region of the appliance's housing. The length of the toothed rack is independent from the housing's dimensions, and the slider may be moved up to the outer edges of the housing.

Although flexible toothed racks enable a space saving construction, one problem of them, is in some applications, is that they have to work under quite different temperature conditions reaching from minus 20° C. or even lower up to room temperature or even higher.

German Patent Application laid open to public inspection No. 10 2004 007306 suggested the use of polyoxymethlene which, however, lacks flexibility under extreme conditions.

A further problem is that there are contradictory requirements in that the toothed rack should be (and remain over time and/or a certain temperature range) flexible, while the teeth and their distances should be relative rigid to provide the required precision.

Yet another problem in the context of flexibility/rigidity is that a toothed rack of some limited flexibility has a tendency of moving away from an radial inner guide surface after having bend. This, however affects the engagement of the pinion—which, according to the above mentioned DE-document is situated at the radial inner side with the teeth of the toothed racks, up to situations where the teeth of both even disengage from one another.

A further problem of the prior art consists in that the respective pinion has to be connected to a rotating shaft of a certain length. However, with specimen stages and/or microscopes of different sizes, the length of the shaft has to be adapted. This was not possible with the constructions of the prior art.

### SUMMARY OF THE INVENTION

It is an object of the present invention to overcome the above-mentioned disadvantages and, in particular, to find a design of a toothed rack and its driving arrangement which provides both flexibility and accuracy.

A further object is to provide a driving arrangement which is adaptable to the respective application.

In a first aspect of the present invention, the flexibility/accuracy is solved by providing an elongated toothed rack of a halogenated ethylene material of a maximum static pressure load without substantial deformation of less than 1 N/mm². This halogenated material is preferably a polytetrafluor ethylene material.

Since halogenated ethylene, and particularly polytetrafluor ethylene, in order to be formed into an elongated toothed rack, could normally only be sintered, and then would not possess the necessary flexibility and, at the same time, the rigidity of the teeth necessary to provide the required accuracy, it has turned out that forming has to be done in two steps:
1. extrusion of the material so as to obtain long macromolecule chains in a substantially parallel configuration so as to confer a certain flexibility. To this end, a material of an admissible pressure of less than 1 N/mm ,preferably of about 0.7 N/mm², has been found to be ideal, because otherwise the material tends to a higher rigidity. The term “admissible pressure” is customarily used in tables in the context of polytetrafluor ethylenes, for instance by suppliers as Kaindl in Vienna or Faigle in Hard (Austria).
2. In the second step, the outer surface of the extruded elongated rod is slightly heated, preferably simply by machining or cutting the teeth into the material. This has a surprising effect: Although halogenated ethylenes, such as polytetrafluor ethylene, are known to be hardly affected by temperature, even a relative low temperature above room temperature results in a higher rigidity. Without wishing to be bound to a theory, it is most probable that the increase in temperature affects the plasticizer diminishing its content. Thus by locally heating the surface during machining the teeth, the respective surface area becomes harder or more rigid. It has been found that a locally applied heat of at least 40° C., for example 50° C. (during the short time of machining) is sufficient to provide the desired rigidity.

To avoid that this surface rigidification affects the body's flexibility, which is also necessary, it is preferred to cool the machined toothed rack immediately down, preferably to room temperature or lower, in a third step.

Thus, it will be understood that the present invention relates also to a method of producing a toothed rack that has both a flexible body and a rigid toothed surface.

In a second aspect of the present invention, it is provided that the respective pinion is connected to the associated shaft by a releasable coupling to enable an exchange of the shaft(s) and, thus, to enable assembling the specimen stage to microscopes or appliances of different size needing shafts of different lengths.

### BRIEF DESCRIPTION OF THE DRAWINGS

Further details and advantages will become apparent from the following description with reference to the accompanying drawings, in which

FIG. 1 shows a perspective view of a specimen stage formed as a cross slide with the arrangement of plates each being displaceable in either the direction of the x or the y coordinates by means of an actuator device;

FIG. 2 is another perspective view, turned upside down with respect to FIG. 1, illustrating the driving mechanism including a flexible toothed rack for one of the displaceable plates;

FIG. 3 is a detail of FIG. 2 at an enlarged scale;

FIG. 4 is a perspective view of an embodiment of the flexible toothed rack, while

FIG. 5 shows a plan view of an embodiment of the toothed rack having teeth inclined with respect to the plane of its longitudinal axis;

FIG. 6 is a cross-sectional view of the guiding arrangement for the toothed rack; and

FIG. 7 is a detail shown as a perspective view similar to FIG. 2, but of an alternative embodiment.

### DETAILED DESCRIPTION OF THE DRAWINGS

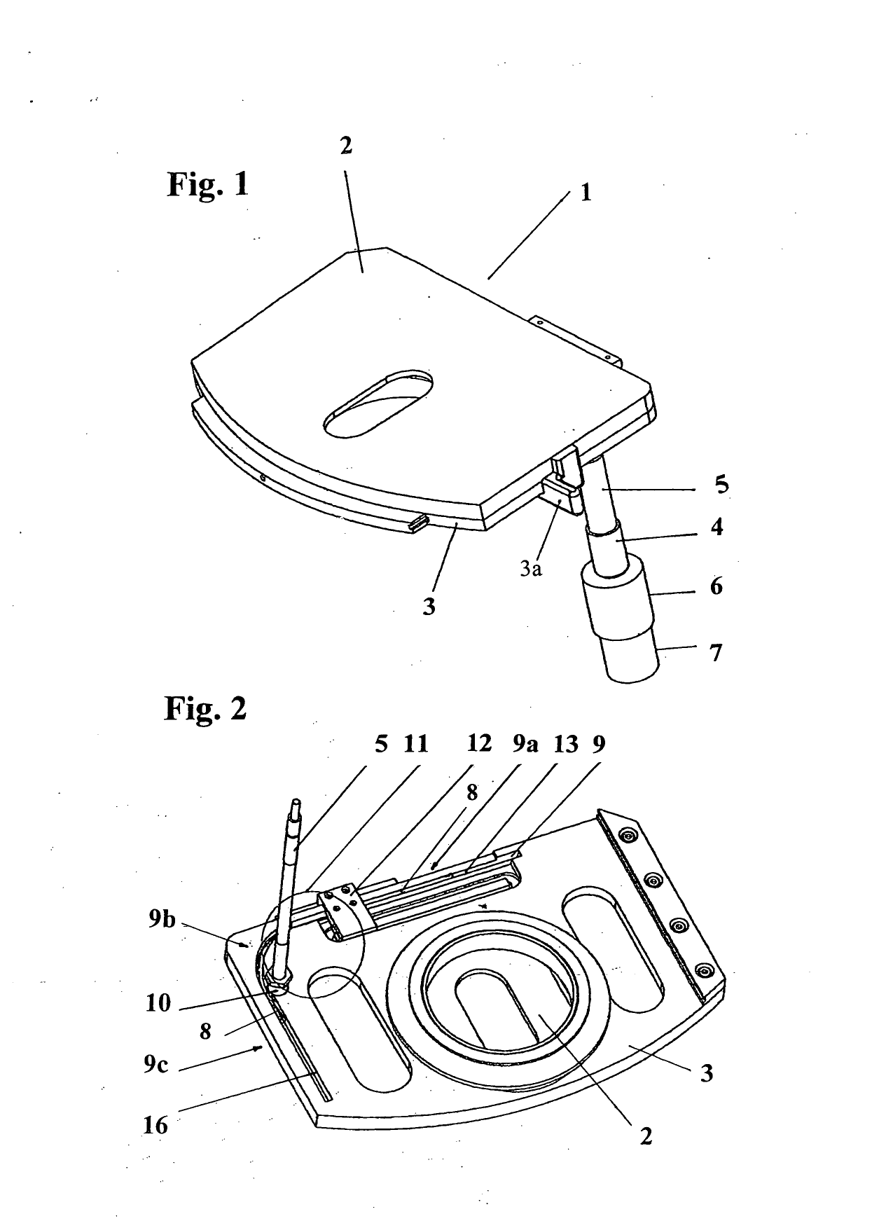

In FIG. 1, a specimen stage 1, suitably used for a microscope (not shown), is represented. This specimen stage comprises at least two horizontal plates 2 and 3 supported by a suitable support arrangement, such as consoles 3a. The plate 2 is linearly displaceable, e.g. in the direction of the x coordinate, i.e. in one direction substantially parallel to one of its sides, while plate 3, which in turn supports the plate 2, in the case of a cross-slide will be displaceable in a direction corresponding to the y coordinates, i.e. perpendicularly to the direction of displacement of plate 2, as will be described later in detail. In some cases, one of the x or y directions may be sufficient. Support console 3a may be connected to a foot portion or holding portion of a microscope.

For displacing the plates 2 and 3, there are suitably coaxial rotatable shafts 4 and 5 (if both plates are to be displaceable) actuated by turning knobs 6 and 7. Suitably, turning knob 7 is connected to the inner shaft 5, while turning knob 6 may be connected to shaft 4, although the arrangement could also be reversed. The above-mentioned displacement of the plates 2 and 3 serves the purpose to enable various details of an object arranged about in the center of the specimen stage to be observed. Each shaft 4 or 5 is associated to the movement of a different one of the plates 2 and 3. Thus, it will be apparent that, although a coaxial arrangement of the shafts 4, 5 is space saving and facilitates manual actuation by knobs 6, 7, it would also be possible to have the two shafts (and knobs) separated.

In FIG. 2, the plates 2 and 3 are represented upside down with respect to FIG. 1 in order to illustrate the driving mechanism and the transmitting mechanism for converting the rotary motion of shaft 5, actuated by turning knob 7 (FIG. 1), into a linear displacement of the displaceable plate 2 which in this figure is below the plate 3.

Plate 3 has a groove 9 which includes a first linear section 9a, a bent section 9b and a further linear section 9c which, for example extends substantially (but not necessarily) perpendicularly to section 9a. In this groove 9 runs and extends a flexible toothed rack 8 which is represented at a larger scale in FIGS. 4 and 5. To enable displacement of the toothed rack 8 within the groove 9, the rack 8 has a length shorter than that of the groove 9.

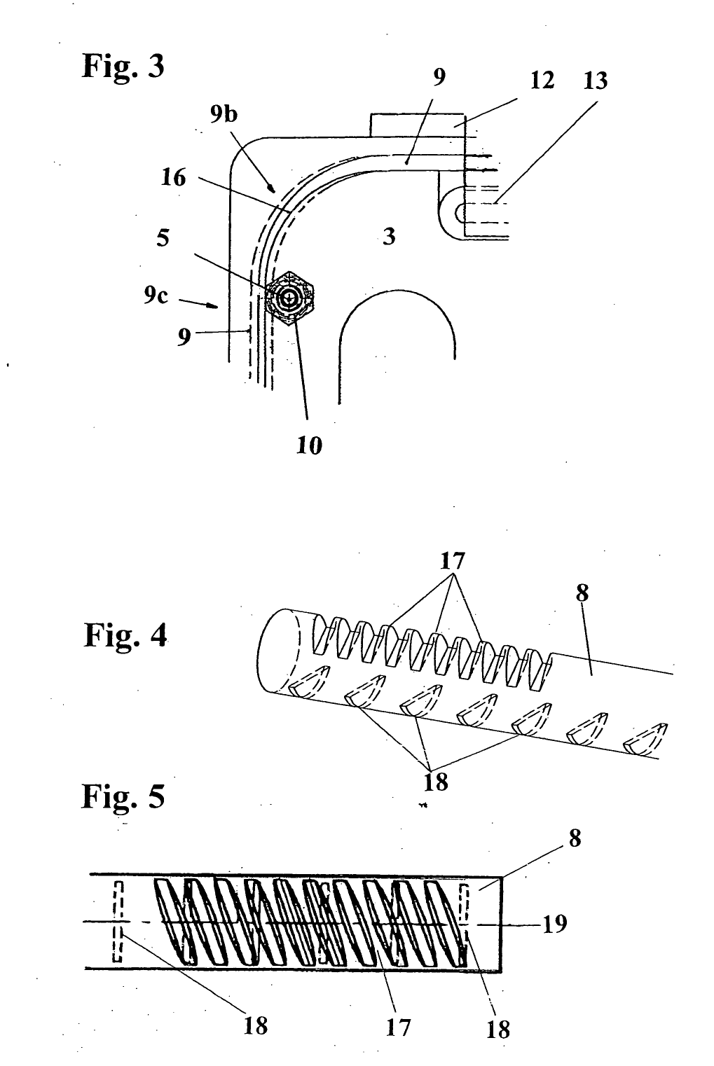

A pinion 10 coupled to the shaft 5 engages the teeth 17 (FIG. 4) of the toothed rack 8 so as to impart a sliding movement to the toothed rack 8. In the embodiment shown in FIG. 2, the pinion 10, although being situated within the range of said bent section 9b, is located at the immediately joining portion of the linear section 9c. Accordingly, the teeth (17 in FIG. 4) of the toothed rack 8 are at least about the radial inner side with respect to the bent section 9b (see also FIG. 3). The pinion is rotatably supported on the plate 3. This detail is represented in FIG. 3 at a larger scale, where the toothed rack is omitted for the sake of simplicity.

In order to convert the rotary motion of the pinion 10 into a linear motion of the plate 2, there is a coupling plate 12 moving with the toothed rack 8. Furthermore, the coupling plate 12 is connected to the plate 2 in a manner not shown, but known in the art. The coupling plate 12 may be merely frictionally connected to the rack 8 and or to the plate 2. Since the coupling plate 12 moves in the linear section 9a, the plate 2 is guided in the same direction which may be called the x coordinate both by the toothed rack 8 and the coupling plate 12, on the one hand, and by slot-like guiding surfaces 13 of the plate 3.

Therefore, if the rotary shaft 5 is turned by its turning knob 7 the transmitting mechanism of pinion 10 and toothed rack 8 moves the plate 2, situated below the plate 3 (when seen in FIG. 2) which supports it, along the guiding surfaces 13 and, thus, in x direction of the specimen stage 1. By bending the groove 9 in the supporting plate 3, the displacement stroke of the displaceable plate 2 my be relative long without resulting in a toothed rack that projects laterally beyond the contours of the specimen stage I when it reaches an end position.

If the specimen stage should be formed as a cross-slide to enable movement in directions corresponding to the x and y coordinates, the support consoles or a corresponding support plate similar to plate 3 in FIG. 2 has to support another pinion which is coupled to shaft 4, but with a coupling plate moving along the other linear section 9c. Thus, it is clear that with a cross-slide one of the shafts 4, 5 has to penetrate the respective pinion (not shown) coupled to the other shaft 5 or 4 to be coupled with the pinion 10 supported on plate 3.

The toothed rack, as has already been mentioned, is illustrated in detail in FIGS. 3 and 4. Particularly a comparison of FIGS. 3 and 4 makes it clear that The rack 8 has to possess sufficient flexibility to be bent over its length when moving through the bent section 9b. To enhance flexibility, the toothed rack 8 may comprise incisions 18 at the radial inside, particularly if it is used in an embodiment according to FIG. 7, as will be explained later. On the other hand, it is paramount that the teeth 17 do not bend but keep their shape so as to enable a precise engagement with the teeth of pinion 10 and an accurate displacement of plate 2. Thus, it is clear that this toothed rack 8 is subject to contradictory requirements.

To solve the problem, the toothed rack 8 is formed of an extruded rod of a halogenated ethylene material, preferably polytetrafluor ethylene (PTFE), of a maximum static pressure load without substantial deformation of less than 1 N/mm². This is a relative low admissible pressure per surface area and provides a relative good flexibility to the material. Particularly preferred is a PTFE of more than 0.5 N/mm², e.g. of 0.7 N/mm ².

With such an elastic material, however, the teeth 17 would bend and would prevent an accurate adjustment of the position of plate 2. Surprisingly, however, it has been found that with a heat treatment just of the surface of the toothed rack, the surface becomes more rigid. A possible reason for this phenomenon has been explained above.

Since the teeth 17 have to be cut or machined into the surface anyway, it is suitable to use the heat created by machining for hardening the surface only, but to maintain the body of the rack 8 in its flexible state. In order to keep this under control, it is suitable to cool the rack 8 immediately after machining where a heat higher than about 40° C., e.g. of 50° C., is created. In this way, a toothed rack 8 is obtained that has both a flexible core or body and a hardened surface including the teeth 17.

The flexible toothed rack 8 can have various shapes and various types of teeth. The teeth may each lie in a plane perpendicular to the longitudinal axis 19 of the toothed rack, but it is preferred, as is shown in FIG. 4, to provide teeth inclined with respect to the longitudinal axis 19, because in this way the motion imparted to the plate 2 is smoother. By providing an angle of inclination between 20° and 30° and a module of about 0.5, best results as to precision have been achieved. In a practical example the angle of inclination was. 21.4°.

As may be seen in FIG. 4, there are, preferably wedge shaped, incisions 18 at the radial inner side of the toothed rack 8 (with respect to the curved section 9b) so as to enhance bending. At least in the case of the embodiment of FIG. 7, the incisions 18 are about diametrically opposite the teeth 17. These incisions 18 are, as shown in FIG. 5, suitably cut in a plane perpendicular to the longitudinal axis 19 of the rack. In FIG. 4, the incisions 18 are spaced such that the distance between adjacent teeth 17 is smaller than the distance between adjacent incisions 18. However, this is not necessary in each case, because, just in the embodiment of FIG. 7, it may be useful to provide about the same distance between teeth and incisions 18. Because the distance of the incisions 18 will greatly depend on the radius of curvature of the bent section 9b (FIG. 2). Thus, it would even be possible to chose the distance of the incisions 18 smaller than that of the teeth 17. The shape of the incisions may be wedge-shaped, as shown, but can have also a different shape to adapt it best to the bending of the rack 18. Moreover, it may be useful to omit the teeth in the end regions of the rack 8 for a better guidance in the groove 9.

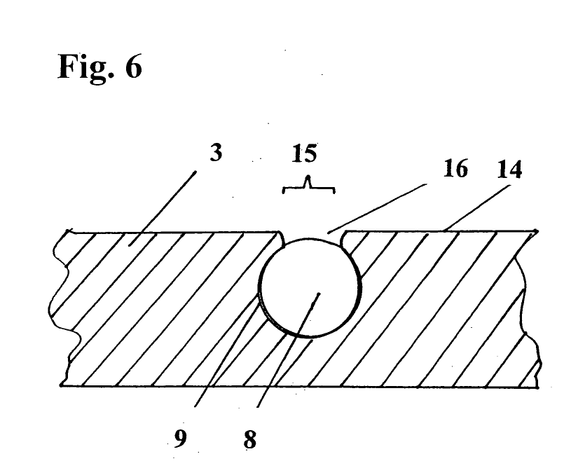

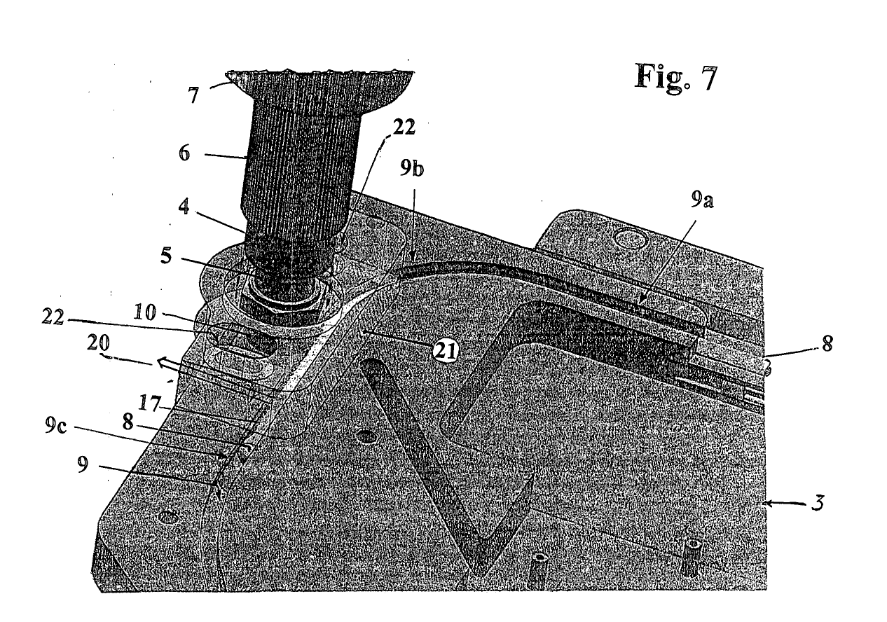

As may be seen in FIG. 6, the groove 9 has such a depth within the support plate 3 that the introduced flexible toothed rack 8 is totally below the surface 14 of the support plate 3. The width 15 of the slot 16 formed by the groove at the surface 14 of the support plate 3 may be different in different sections 9a, 9b and 9c. In the section 9a, where the coupling plate 12 is located, the width 15 of the slot 16 corresponds conveniently to the maximum width of the groove 9. In the curved or bent section 9b of the groove, however, it is preferred if the width 15 of the slot 16 gradually decreases over the length, while in the linear section 9c, where the pinion 10 is arranged, the width 15 is significantly smaller than the largest width of the groove 9 (see also FIG. 3).

While an arrangement of the pinion 10 in the range of the bent section 9b and at the radial inner side may profit from the fact that the pinion 10 is surrounded by the toothed rack 9 over a certain angle, it has been found that the contradictory requirements as to flexibility and rigidity may, in the present application of a flexible toothed rack, lead to another problem: since it is difficult to provide sufficient flexibility and, at the same time, sufficient rigidity (at least without manufacturing the toothed rack of different, assembled components which would raise the costs), one has to look for a compromise. Therefore, even the flexible core of the toothed rack 8 may have a tendency to spread off in the region of the bent section 9b, as is illustrated by arrow 20 of FIG. 7. This means that it would disengage the teeth of the rack 8 from those of the pinion 10, if the pinion were at the radial inner side, as represented in FIG. 2. Therefore, it is most advantageous to arrange the pinion 10 at the radial outer side as may be seen in FIG. 7. This facilitates also cooperation of the teeth 17 with the pinion 10 on the one hand, without interfering with the effect of the incisions 18 (vide FIG. 4) at the diametrically opposite side, on the other hand. To the contrary, the elasticity of the rack will result in an interengagement of the teeth free from play so that the precision of the adjustment or displacement of the plate 2 or 3 is improved.

FIG. 7 shows, once more, some details of the driving arrangement. Although only one pinion 10 is shown which is coupled to the inner one 5 of the shafts 4, 5, it is apparent, that shaft 4 ends in a plane parallel to that of the surface of plate 3. Thus, if plate 3 is to move in a perpendicular direction to that of plate 2 to form a cross-slide, the lower end of the shaft 4 will be coupled to another pinion supported by a third (in FIG. 7: upper) support plate, through which the shaft 5 penetrates. While coupling to the respective pinion may be effected in a known manner, e.g. by providing a centered hole in the pinion deviating from a circular shape (such as star-shaped, or circular, but with a flattened region or the like), through which the shaft 4 or 5 of a complementary outer cross-sectional shape extends in a coupled condition, it may be possible to provide a bearing block 21 (indicated as a transparent block) which forms a unit with the coaxial shafts 4 and 5 and may be fastened to the plate 3 by screws passed through slot-holes 22. In this way, it is easy to provide pairs of shafts 4, 5 of different length and/or size and/or provided selectively with a manually actuable turning knob or a connection to a motor drive, and to mount and couple such pair of shafts 4, 5 to the pinion or pinions 10 in accordance with the requirements, the size of the microscope, and so on, simply by coupling the pair via their bearing block 21.

### EXAMPLE

A rod of polytetrafluor ethylene (PTFE) of 273 mm in length and 4 mm in diameter was cut, after having been extruded to obtain substantially parallel macro-molecule chains, by a tooth cutter to form teeth in the form of mere cuts rather than giving them a special shape, such as of an involute or cycloide, although that would also be possible. Mere cuts are simpler and quicker to produce so as too keep heating in a restricted range. The toothed section was 160 mm in length beginning at one end of the rack. The cuts or teeth had an angle of 21.4° with respect to the longitudinal axis (see FIG. 5), the distance of the teeth from one another was 1 mm, the width of each cut was 0.3 mm and the depth was 1.3 mm taken from the top of each tooth.

Furthermore, linear incisions were cut at the diametrically opposite (with respect to the teeth) side of the rod in a distance of 1 mm from one another, the width of each incision being 0.3 mm and the depth being 1.3 mm. Thus, it will be clear that the incisions and the teeth were equally dimensioned.

During machining, the rod heated up to somewhat over 50° C., but was cooled in a period of 1 sec. or lower to room temperature (20° C.) to avoid that heat penetrates into the interior of the rack body.

The toothed rack, thus obtained was inserted into a groove 9 of a plate, like plate 3 of the above embodiments, and was driven to run the length of the groove 9 to and fro from one end to the other. After 120,000 runs, no perceptible change of the surface of the toothed rack could be observed.

Within the scope of the present invention, numerous modifications are possible; for example the guide for the toothed rack 8 must not necessarily be in the form of a groove 9, although such groove enhances precision and accuracy.

What is claimed is:

1. A specimen stage comprising
support means;
elongated guide means of a first length on said support means;
a displaceable plate on said support means to be guided by said guide means;
drive means for displacing said plate means, said drive means including:
rotatable shaft means,
actuator means coupled to said shaft means for rotating them,
pinion means coupled to said shaft means for transmitting rotation,
toothed rack means of a second length extending along a longitudinal axis, said rack means comprising teeth which engage said pinion means and being coupled to said displaceable plate means for displacing them, and
coupling means to couple said toothed rack means to said displaceable plate means;
wherein said guide means are in guiding connection to said toothed rack means, said first length being longer than said second length, and comprise at least one curved section,
said toothed rack means, in order to be flexible under different temperature conditions to be able to follow said curved section, being of a halogenated ethylene material of a maximum admissible static pressure load without substantial deformation of less than 1 N/mm².

2. Specimen stage as claimed in claim 1, wherein said halogenated ethylene is a polytetrafluorethylene.

3. Specimen stage as claimed in claim 1, wherein said toothed rack comprises incisions spaced over the length and situated to face said bent section and, thus, to facilitate flexion.

4. Specimen stage as claimed in claim 3, wherein said incisions are spaced such to have about the distance of the teeth of said toothed rack ±10%.

5. Specimen stage as claimed in claim 1, wherein said halogenated ethylene admissible static pressure load without substantial deformation of more than 0.5 N/mm².

6. Specimen stage as claimed in claim 1, wherein said halogenated ethylene admissible static pressure load without substantial deformation of about 0.7 N/mm².

7. Specimen stage as claimed in claim 1, wherein said teeth of said toothed rack means are in the shape of mere cuts.

8. Specimen stage as claimed in claim 1, wherein said teeth of said toothed rack means are inclined with respect to the plane of said longitudinal axis.

9. A specimen stage comprising
support means;
elongated guide means of a first length on said support means;
a displaceable plate on said support means to be guided by said guide means;
drive means for displacing said plate means, said drive means including:
rotatable shaft means,
actuator means coupled to said shaft means for rotating them,
pinion means coupled to said shaft means for transmitting rotation,
toothed rack means of a second length, said rack means comprising teeth which engage said pinion means and being coupled to said displaceable plate means for displacing them, and
coupling means to couple said toothed rack means to said displaceable plate means;
wherein said guide means are in guiding connection to said toothed rack means, said first length being longer than said second length, and comprise at least one curved section and at least one linear section, said teeth of said toothed rack means being arranged to face the radial outside when bend in said curved section, while said pinion means are arranged accordingly to face the outside of said toothed rack means and within the range of said bent section.

10. Specimen stage as claimed in claim 7, wherein said pinion is arranged to press against said toothed rack at a location just joining said bent section.

11. A specimen stage comprising
support means;
elongated guide means of a first length on said support means;
a displaceable plate on said support means to be guided by said guide means;
drive means for displacing said plate means, said drive means including:
rotatable shaft means,
actuator means coupled to said shaft means for rotating them,
pinion means coupled to said shaft means for transmitting rotation,
first coupling means for interconnecting said shaft means and said pinion means, said coupling means being of the releasable type to enable exchange of said shaft means,
toothed rack means of a second length, said rack means comprising teeth which engage said pinion means and being coupled to said displaceable plate means for displacing them, and
second coupling means to couple said toothed rack means to said displaceable plate means;
wherein said guide means are in guiding connection to said toothed rack means, said first length being longer than said second length, and comprise at least one curved section and at least one linear section.

12. Specimen stage as claimed in claim 9, wherein said shaft means comprise a pair of coaxial shafts.
